(19) United States
(12) Patent Application Publication
(10) Pub. No.: US 2018/0204577 A1
(43) Pub. Date: Jul. 19, 2018

(54) VOICE KEYWORD PERSONALIZATION

(71) Applicant: Sony Corporation, Tokyo (JP)

(72) Inventors: Marvin DeMerchant, San Diego, CA (US); Tracy Barnes, San Diego, CA (US); Sameerajan Suresh, San Diego, CA (US)

(21) Appl. No.: 15/408,669

(22) Filed: Jan. 18, 2017

(51) Int. Cl. G10L 17/24; G10L 15/22

(52) U.S. Cl. CPC G10L 17/24; G10L 2015/088; G10L 15/22

(57) ABSTRACT

A voice keyword can be used to login/switch into a personalized experience on an electronic device. Both the speech of the keyword may be recognized and the audible fingerprint of the keyword can be recognized to match the fingerprint to a specific person.

### FIELD

The present application relates to technically inventive, non-routine solutions that are necessarily rooted in computer technology and that produce concrete technical improvements.

### BACKGROUND

Users of computerized devices such as modern audio video devices (AVD) dislike having to log in and out of individual accounts when multiple people are using the device. This is because such log in/log out typically requires user selection in an onscreen user interface with concomitant password input on an input device such as a remote control that may not be tailored for password-type input. As a consequence, users often use one person's account on a multi-account device. However, as each user account typically is personalized for the associated user, sharing a single user account created a mixed up experience in which users often see content and recommendations that are not theirs.

### SUMMARY

As disclosed herein, each one of plural users can create his or her own personalized name or greeting to use when inputting voice commands to an electronic device. If the recognized voice command matches both a recognized word and a user's voice fingerprint, the electronic device responds by switching into the personalized experience for that particular user. A personal assistant may essentially be provided that controls and customizes all of a user's preferences including TV shows, radio stations, news articles, areas of interest. Present principles can be used on any device that can be used by more than one user where personal settings and preferences can enhance the experience such as a car, computer, tablet, lighting and home control. Present principles may also be used as a security keyword phrase to alert police or call for help in a medical emergency.

Accordingly, a device includes at least one computer memory that is not a transitory signal and that includes instructions executable by at least one processor to receive digitized voice input, and to execute speech recognition on the digitized voice input to render a speech result indicating at least one word. The instructions are further executable to execute speaker recognition on the digitized voice input to render a speaker result indicating at least one person. The instructions are executable to, responsive to the speech result satisfying a first criteria and the speaker result satisfying a second criteria, establish on a display device at least one setting associated with the at least one person. In contrast, responsive to the speech result satisfying the first criteria and the speaker result not satisfying the second criteria, no setting on the display device is changed, and likewise, responsive to the speech result not satisfying the first criteria and the speaker result satisfying the second criteria, no setting on the display device is changed.

In some embodiments, the setting includes an icon arrangement on a home page and/or a ratings limitation. Other settings to be personalized are contemplated.

In example implementations, the instructions can be executable to, responsive to the speech result satisfying a first criteria and the speaker result satisfying a second criteria, present on the display device a welcome message. The first criteria may include a match with a correct passcode while the second criteria may include a match with a stored speaker template.

In some embodiments, the instructions can be executable to, responsive to receiving a correct passcode from a correct associated speaker at least “N” times within a time period, stop changing settings on the display device for a timeout period.

In another aspect, a method includes receiving, by voice, a first keyword from a first person. The method includes responsive to the first keyword, logging the first person to a computing device and switching into a first personalized experience for the first person on the computing device. The method also includes receiving by voice a second keyword from a second person and responsive to the second keyword, logging in the second person to the computing device and switching into a second personalized experience for the second person on the computing device.

In another aspect, an apparatus includes one or more processors, one or more displays controllable by the processor, and one or more storages with instructions executable by the processor for receiving first digitized voice input from first and second people at a first time of day. The instructions are executable for executing speech recognition on the first digitized voice input to render a first multi-person speech result, and responsive to the first multi-person speech result satisfying a first criteria and responsive to the first time of day, establishing on the display a first multi-person personalization for the first and second people. The instructions are further executable for receiving second digitized voice input from the first and second people at a second time of day and executing speech recognition on the second digitized voice input to render a second multi-person speech result. Responsive to the second multi-person speech result satisfying the first criteria and responsive to the second time of day, the instructions are executable for establishing on the display a second multi-person personalization for the first and second people. The second multi-person personalization is different from the first multi-person personalization. Thus, different personalizations can be established for the same two or more people based on respective times of day or days of the week.

The details of the present disclosure, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system including an example in accordance with present principles;

FIG. 2 is a partially schematic view of a specific example system with two UHD displays mounted on a wall side by side;

FIGS. 3-5 are schematic diagrams illustrating present principles;

FIG. 6 is a flow chart of example logic for establishing a voice log-on;

FIG. 7 is a screen shot of an example user interface (UI) related to FIG. 6;

FIGS. 8 and 9 are flow charts of example logic for processing voice log-ons; and

FIG. 10 is a screen shot of an example UI related to FIG. 9.

### DETAILED DESCRIPTION

This disclosure relates generally to computer ecosystems including aspects of consumer electronics (CE) device based user information in computer ecosystems. A system herein may include server and client components, connected over a network such that data may be exchanged between the client and server components. The client components may include one or more computing devices including portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, operating systems from Microsoft, or a Unix operating system, or operating systems produced by Apple Computer or Google. These operating environments may be used to execute one or more browsing programs, such as a browser made by Microsoft or Google or Mozilla or other browser program that can access web applications hosted by the Internet servers discussed below.

Servers may include one or more processors executing instructions that configure the servers to receive and transmit data over a network such as the Internet. Or, a client and server can be connected over a local intranet or a virtual private network. A server or controller may be instantiated by a game console such as a Sony Playstation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/ or made available in a shareable library.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

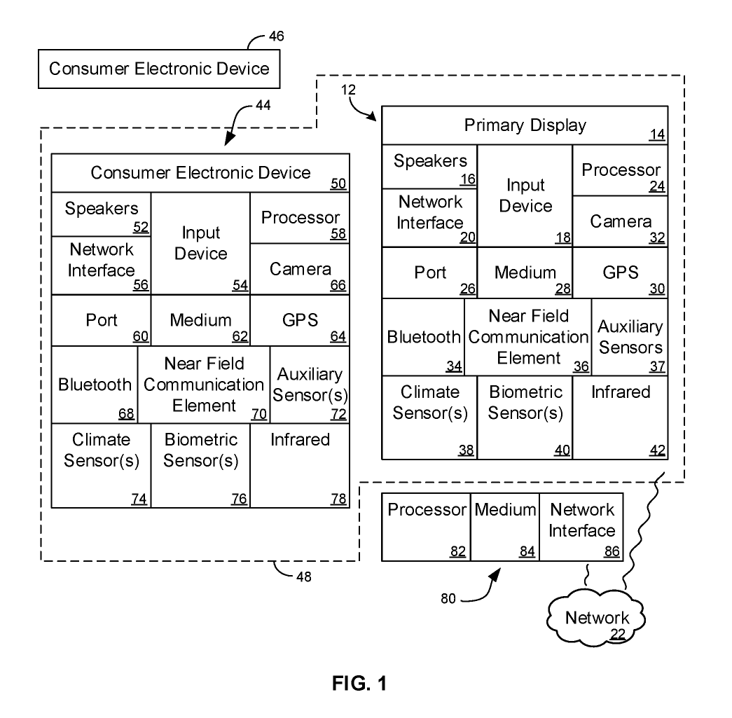

Now specifically referring to FIG. 1, an example ecosystem 10 is shown, which may include one or more of the example devices mentioned above and described further below in accordance with present principles. The first of the example devices included in the system 10 is an example primary display device, and in the embodiment shown is an audio video display device (AVDD) 12 such as but not limited to an Internet-enabled TV. Thus, the AVDD 12 alternatively may be an appliance or household item, e.g. computerized Internet enabled refrigerator, washer, or dryer. The AVDD 12 alternatively may also be a computerized Internet enabled (“smart”) telephone, a tablet computer, a notebook computer, a wearable computerized device such as e.g. computerized Internet-enabled watch, a computerized Internet-enabled bracelet, other computerized Internet-enabled devices, a computerized Internet-enabled music player, computerized Internet-enabled head phones, a computerized Internet-enabled implantable device such as an implantable skin device, etc. Regardless, it is to be understood that the AVDD 12 is configured to undertake present principles (e.g. communicate with other CE devices to undertake present principles, execute the logic described herein, and perform any other functions and/or operations described herein).

Accordingly, to undertake such principles the AVDD 12 can be established by some or all of the components shown in FIG. 1. For example, the AVDD 12 can include one or more displays 14 that may be implemented by a high definition or ultra-high definition “4K” or “8K” (or higher resolution) flat screen and that may be touch-enabled for receiving consumer input signals via touches on the display. The AVDD 12 may include one or more speakers 16 for outputting audio in accordance with present principles, and at least one additional input device 18 such as e.g. an audio receiver/microphone for e.g. entering audible commands to the AVDD 12 to control the AVDD 12. The example AVDD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface. It is to be understood that the processor 24 controls the AVDD 12 to undertake present principles, including the other elements of the AVDD 12 described herein such as e.g. controlling the display 14 to present images thereon and receiving input therefrom. Furthermore, note the network interface 20 may be, e.g., a wired or wireless modem or router, or other appropriate interface such as, e.g., a wireless telephony transceiver, or Wi-Fi transceiver as mentioned above, etc.

In addition to the foregoing, the AVDD 12 may also include one or more input ports 26 such as, e.g., a USB port to physically connect (e.g. using a wired connection) to another CE device and/or a headphone port to connect headphones to the AVDD 12 for presentation of audio from the AVDD 12 to a consumer through the headphones. The AVDD 12 may further include one or more computer memories 28 that are not transitory signals, such as disk-based or solid state storage (including but not limited to flash memory). Also in some embodiments, the AVDD 12 can include a position or location receiver such as but not limited to a cellphone receiver, GPS receiver and/or altimeter 30 that is configured to e.g. receive geographic position information from at least one satellite or cellphone tower and provide the information to the processor 24 and/or determine an altitude at which the AVDD 12 is disposed in conjunction with the processor 24. However, it is to be understood that that another suitable position receiver other than a cellphone receiver, GPS receiver and/or altimeter may be used in accordance with present principles to e.g. determine the location of the AVDD 12 in e.g. all three dimensions.

Continuing the description of the AVDD 12, in some embodiments the AVDD 12 may include one or more cameras 32 that may be, e.g., a thermal imaging camera, a digital camera such as a webcam, and/or a camera integrated into the AVDD 12 and controllable by the processor 24 to gather pictures/images and/or video in accordance with present principles. Also included on the AVDD 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the AVDD 12 may include one or more auxiliary sensors 37 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command, etc.) providing input to the processor 24. The AVDD 12 may include still other sensors such as e.g. one or more climate sensors 38 (e.g. barometers, humidity sensors, wind sensors, light sensors, temperature sensors, etc.) and/or one or more biometric sensors 40 providing input to the processor 24. In addition to the foregoing, it is noted that the AVDD 12 may also include an infrared (IR) transmitter and/or IR receiver and/or IR transceiver 42 such as an IR data association (IRDA) device. A battery (not shown) may be provided for powering the AVDD 12.

Still referring to FIG. 1, in addition to the AVDD 12, the system 10 may include one or more other CE device types. In one example, a first CE device 44 may be used to control the display via commands sent through the below-described server while a second CE device 46 may include similar components as the first CE device 44 and hence will not be discussed in detail. In the example shown, only two CE devices 44, 46 are shown, it being understood that fewer or greater devices may be used.

In the example shown, to illustrate present principles all three devices 12, 44, 46 are assumed to be members of an entertainment network in, e.g., in a home, or at least to be present in proximity to each other in a location such as a house. However, for illustrating present principles the first CE device 44 is assumed to be in the same room as the AVDD 12, bounded by walls illustrated by dashed lines 48.

The example non-limiting first CE device 44 may be established by any one of the above-mentioned devices, for example, a portable wireless laptop computer or notebook computer, and accordingly may have one or more of the components described below. The second CE device 46 without limitation may be established by a wireless telephone.

The first CE device 44 may include one or more displays 50 that may be touch-enabled for receiving consumer input signals via touches on the display. The first CE device 44 may include one or more speakers 52 for outputting audio in accordance with present principles, and at least one additional input device 54 such as e.g. an audio receiver/microphone for e.g. entering audible commands to the first CE device 44 to control the device 44. The example first CE device 44 may also include one or more network interfaces 56 for communication over the network 22 under control of one or more CE device processors 58. Thus, the interface 56 may be, without limitation, a Wi-Fi transceiver, which is an example of a wireless computer network interface. It is to be understood that the processor 58 may control the first CE device 44 to undertake present principles, including the other elements of the first CE device 44 described herein such as e.g. controlling the display 50 to present images thereon and receiving input therefrom. Furthermore, note the network interface 56 may be, e.g., a wired or wireless modem or router, or other appropriate interface such as, e.g., a wireless telephony transceiver, or Wi-Fi transceiver as mentioned above, etc.

In addition to the foregoing, the first CE device 44 may also include one or more input ports 60 such as, e.g., a USB port to physically connect (e.g. using a wired connection) to another CE device and/or a headphone port to connect headphones to the first CE device 44 for presentation of audio from the first CE device 44 to a consumer through the headphones. The first CE device 44 may further include one or more computer memories 62 such as disk-based or solid state storage. Also in some embodiments, the first CE device 44 can include a position or location receiver such as but not limited to a cellphone and/or GPS receiver and/or altimeter 64 that is configured to e.g. receive geographic position information from at least one satellite and/or cell tower, using triangulation, and provide the information to the CE device processor 58 and/or determine an altitude at which the first CE device 44 is disposed in conjunction with the CE device processor 58. However, it is to be understood that that another suitable position receiver other than a cellphone and/or GPS receiver and/or altimeter may be used in accordance with present principles to e.g. determine the location of the first CE device 44 in e.g. all three dimensions.

Continuing the description of the first CE device 44, in some embodiments the first CE device 44 may include one or more cameras 66 that may be, e.g., a thermal imaging camera, a digital camera such as a webcam, and/or a camera integrated into the first CE device 44 and controllable by the CE device processor 58 to gather pictures/images and/or video in accordance with present principles. Also included on the first CE device 44 may be a Bluetooth transceiver 68 and other Near Field Communication (NFC) element 70 for communication with other devices using Bluetooth and/or NFC technology, respectively. An example NFC element can be a radio frequency identification (RFID) element.

Further still, the first CE device 44 may include one or more auxiliary sensors 72 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command, etc.) providing input to the CE device processor 58. The first CE device 44 may include still other sensors such as e.g. one or more climate sensors 74 (e.g. barometers, humidity sensors, wind sensors, light sensors, temperature sensors, etc.) and/or one or more biometric sensors 76 providing input to the CE device processor 58. In addition to the foregoing, it is noted that in some embodiments the first CE device 44 may also include an infrared (IR) transmitter and/or IR receiver and/or IR transceiver 78 such as an IR data association (IRDA) device. A battery (not shown) may be provided for powering the first CE device 44.

The second CE device 46 may include some or all of the components shown for the CE device 44.

Now in reference to the afore-mentioned at least one server 80, it includes at least one server processor 82, at least one computer memory 84 such as disk-based or solid state storage, and at least one network interface 86 that, under control of the server processor 82, allows for communication with the other devices of FIG. 1 over the network 22, and indeed may facilitate communication between servers and client devices in accordance with present principles. Note that the network interface 86 may be, e.g., a wired or wireless modem or router, Wi-Fi transceiver, or other appropriate interface such as, e.g., a wireless telephony transceiver.

Accordingly, in some embodiments the server 80 may be an Internet server, and may include and perform “cloud” functions such that the devices of the system 10 may access a “cloud” environment via the server 80 in example embodiments. Or, the server 80 may be implemented by a game console or other computer in the same room as the other devices shown in FIG. 1 or nearby.

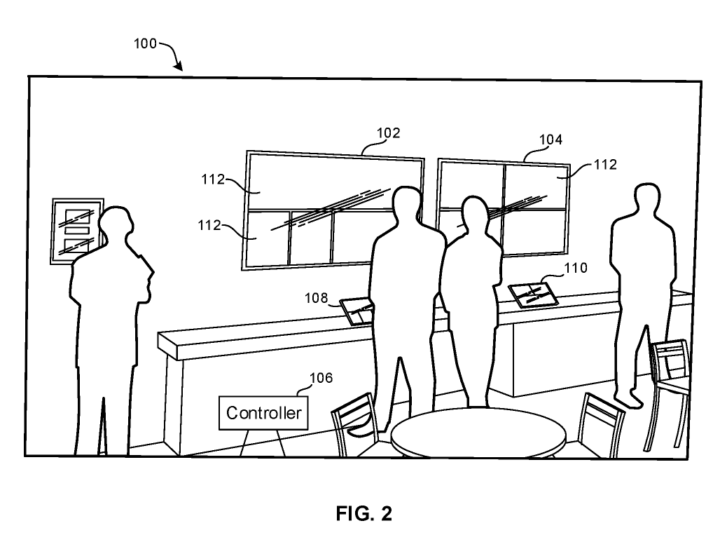

FIG. 2 shows an example system 100 in which one or more ultra high definition (UHD) displays 102, 104 are mounted on a wall, e.g., a wall of a home or a luxury stadium box. The UHD displays 102, 104 may be 4K displays Oor even higher resolution. One or more control devices control presentation of the displays by sending commands wirelessly and/or over wired paths to one or more controllers. In the non-limiting example shown, a controller 106 controls the displays 102, 104, it being understood that a separate controller may be provided for each display. In the non-limiting example shown, content control on the first display 102 is established by a first control device 108 while content control on the second display 104 is established by a second control device 110, it being understood that a single control device may be used to establish control on both displays.

The control devices 108, 110 may be, without limitation, portable computers such as tablet computers or laptop computers (also including notebook computers) or other devices with one or more of the CE device 44 components shown in FIG. 1. The displays 102, 104 may be monitors only and/or may include one or more of the primary display 14 components shown in FIG. 1. The controller 106 may be a personal computer (PC) or game console or server that contains one or more of the components variously shown in FIG. 1. In the non-limiting example shown, the control devices 108, 110 communicate directly with the controller 106 using, e.g., WiFi or Bluetooth; the control devices 108, 110 do not communicate directly with the displays 102, 104. Instead, the controller 106 communicates with the displays 102, 104 to establish presentation thereon in accordance with commands received from the control devices. It is to be understood that while the controller 106 is shown physically separate from the displays in FIG. 2, it may be incorporated within the chassis of a display. As also shown, the displays may present plural contents in respective content windows 112.

The following description inherits the principles and components of the preceding discussion.

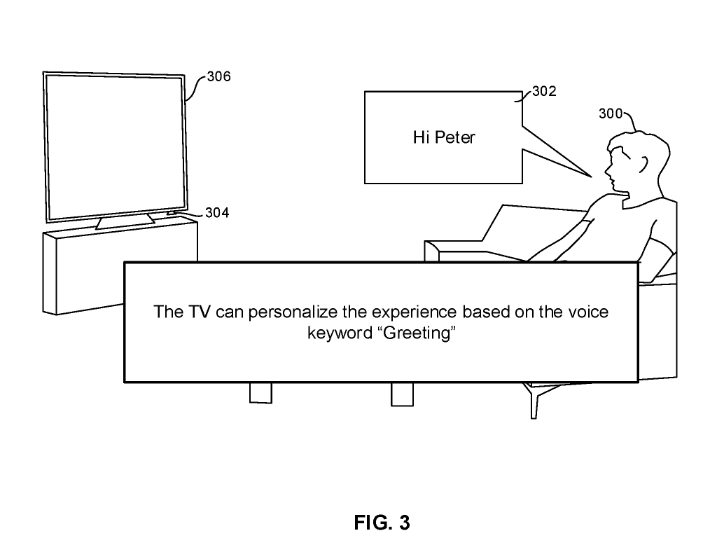

Now referring to FIG. 3, a viewer 300 utters a voice keyword 302 that is detected by a microphone 304 and processed by any of the processors described herein to login/switch into a personalized experience on an electronic device 306 such as any of the electronic devices described herein. Users 300 can create respective personalized names or greetings to use when talking to an electronic device 306, e.g., “Hi Peter” as shown, and the electronic device 306 responds by switching into the personalized experience associated with that keyword 302.

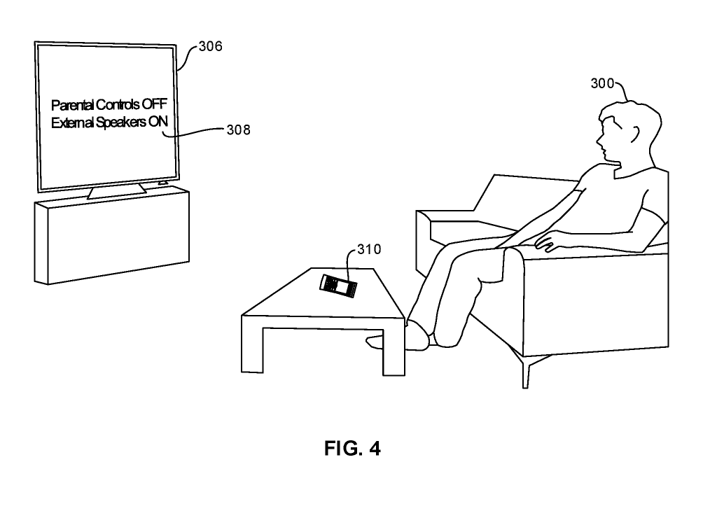

Moving to FIG. 4, the personalized experience may be reflected on a display of the device 306 by presenting a welcome message such as “welcome Peter” and/or a list 308 of settings that have been personalized for the user associated with the received keyword 302. The list may include a ratings limitation and a speaker configuration as shown, it being understood that other personalized settings may be shown on the list.

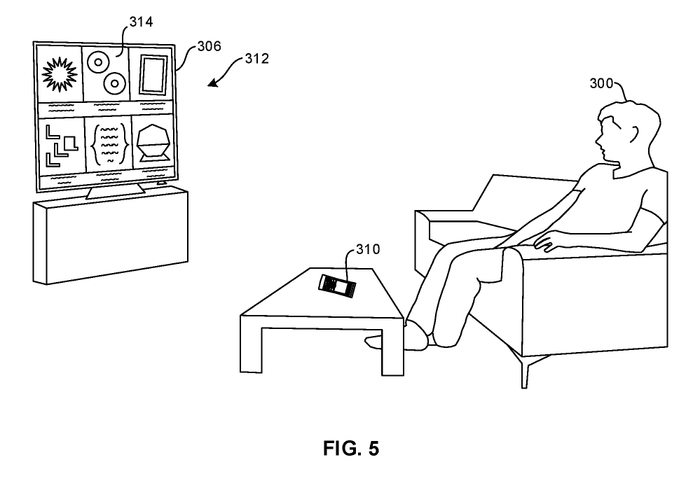

Using an input device such as the microphone 304 or a remote control (RC) 310, the user can signify “OK” in response to presentation of the list 308, and in response a grid 312 (FIG. 5) may be presented on the device 306 showing an arrangement of icons or tiles 314 each presenting content that has been selected based on personalization for the user associated with the received keyword 302.

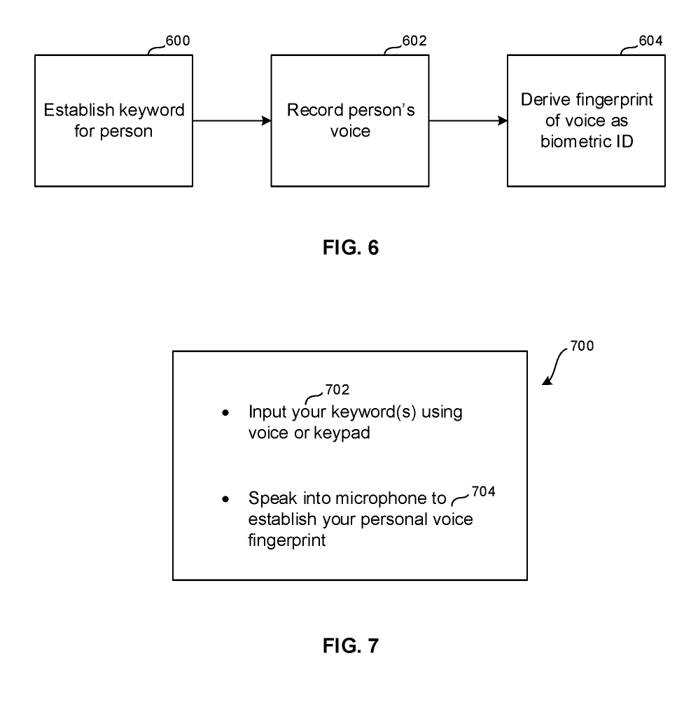

FIGS. 6 and 7 illustrate techniques for establishing keywords. At block 600 in FIG. 6 a keyword is established for one or more of the people who seek to use the electronic device 306 (or system of devices in a home network, for instance). The keyword may be entered using the user interface (UI) 700 of FIG. 7, in which the user is prompted at 702 to enter a keyword using voice input or a keypad device such as the RC 310, typically along with the person's identity that is associated with favorites or other personalization files. The keyword essentially establishes an alpha-numeric string that is recorded and associated with the person as a password for that person.

Block 602 of FIG. 6 indicates that the person's voice also may be recorded according to a prompt 704 in the UI of FIG. 7 to establish a voice fingerprint at block 604 of FIG. 6. This voice fingerprint uniquely identifies the person as a biometric ID. Essentially, the voice input is digitized and processed to render the fingerprint. This may be executed using any one or more of frequency estimation techniques, hidden Markov models, Gaussian mixture models, pattern matching algorithms, neural networks, matrix representation, Vector Quantization, and decision trees. Spectral features output by the recognition technique typically are used as templates against which new digitized speech are compared as discussed further below.

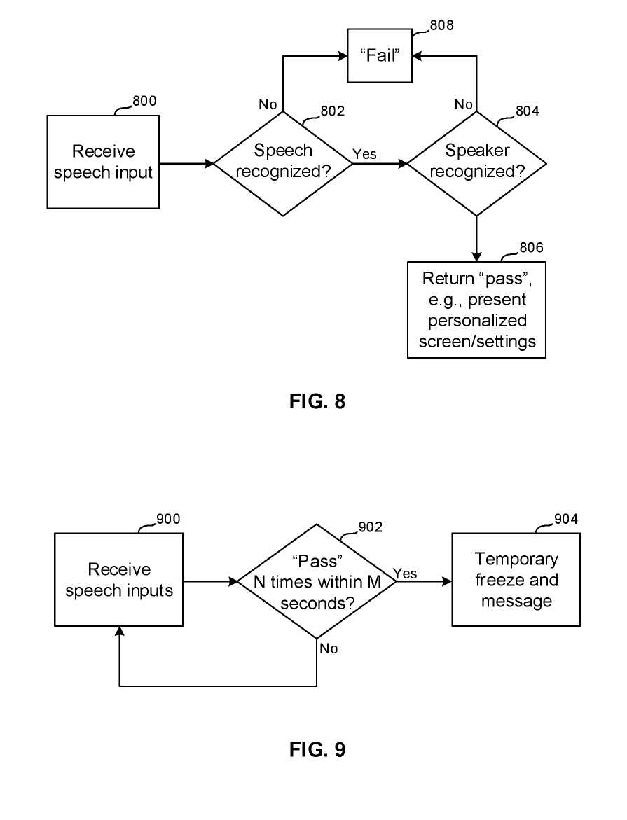

Indeed and now referring to FIG. 8, once a person has established their keyword 302, subsequently the person can configure the electronic device 302 to present a personalized experience for that person as previously described by speaking the keyword, which is received at block 800 and digitized. Moving to decision diamond 802, it is determined whether the speech is recognized, i.e., whether the digitized keyword matches the character string established at block 600 of FIG. 6. This step renders a speech result indicating at least one word.

Responsive to the speech result satisfying a first criteria, e.g., a match with the keyword established at block 600, the logic can move to decision diamond 804 to execute speaker recognition on the digitized voice input to render a speaker result indicating a person. Responsive to the speaker result satisfying a second criteria, e.g., match with the voice fingerprint template established at block 604 in FIG. 6, the logic can move to block 806 to return “pass”, in which case the personalization associated with the person speaking the keyword is established on the electronic device 302 as described above.

However, as shown in FIG. 8, responsive to the speech result satisfying the first criteria and the speaker result not satisfying the second criteria, or responsive to the speech result not satisfying the first criteria and the speaker result satisfying the second criteria, no setting on the electronic device is changed. In this way, a person “B” speaking, wittingly or not, the keyword established by a person “A” will not trigger the electronic device to change setting to person “A”, nor will person “A” trigger a change by simply speaking unless person “A” also happens to speak his keyword. It is to be understood, however, that in alternate embodiments only one of the keyword and voice fingerprint, if properly matching a template or prestored string, may trigger changing the settings of the electronic device to personalize it for the speaker.

In either case, a first keyword can be received by voice input from a first person, and responsive to the first keyword being correct, the first person is logged into the electronic device, the settings of which are switched into a first personalized experience for the first person. Then, a second keyword can be received by voice from a second person, and responsive to the second keyword being correct, the second person can be logged into the computing device, the settings of which are switched from the first personalized experience for the first person to a second personalized experience for the second person.

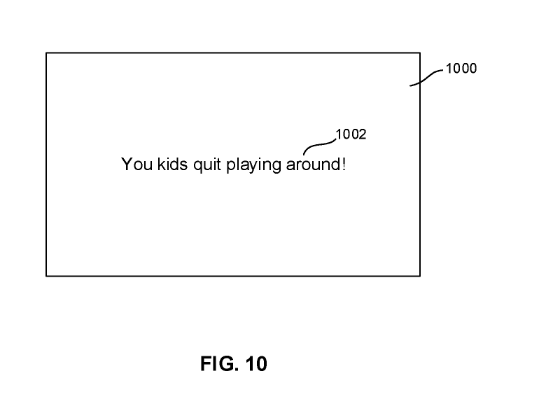

FIG. 9 shows an optional feature that may be provided to avoid two people rapidly switching personalization settings on the electronic device 302, such as two children repeatedly speaking their keywords one after the other. Speech inputs are received at block 900 and processed as described above. At block 902, responsive to receiving a correct passcode from a correct associated speaker at least “N” times within a time period such as “M” seconds, e.g., sixty seconds, the logic can move to block 904 to temporarily freeze the changing of settings for a timeout period such as three minutes. A UI 1000 (FIG. 10) may be presented on the electronic device with a message 1002 indicating that too many settings changes are being attempted within a threshold period of time.

Multiple keywords may be used by the same person to establish multiple different personalizations. For example, a first keyword may be used to establish a first, standard layout of icons selectable to cause the display to tune to respective network broadcast stations, while a second keyword may be used to establish a “premium” personalization with, for example, icons selectable to tune to respective pay-per0view channels or other specialty channels. Likewise, an easy to remember keyword such as “guest” may invoke a generic icon layout with little or no personalization so that guests are not exposed to the personalizations of residents in the home. The generic layout may be the default icon layout from the manufacturer.

Yet again, a keyword may not be an abstraction but may instead be the actual name of a particular layout. For example, the keyword “Netflix” when detected by the display system may cause the Netflix home page to open with the resident Netflix icons/tiles.

A multiple person learning mode may also be implemented using principles above. An initial personalization may or may not be established, and built on that (or building on no personalization at all), the system can learn multiple person personalizations as follows. Suppose two people both speak their respective passcodes. What the system subsequently is caused to present is associated with both of those persons and also with the day of the week and time of day the content was viewed. The personalization for each individual person typically will be different from the multiple person personalization in this way, and personalizations for the same combination of multiple people may differ depending on time of day.

For example, if the first person is a child whose individual personalization includes cartoon channel selectors and sports channel selectors and the second person is the child's father whose individual personalization includes sports channel and news selectors, and it is noted that sports is typically presented on the display system when both indicate their presence on, e.g., Saturday morning by speaking their keywords, subsequently a first “child-father” personalization may be established using machine learning techniques in which the personalization consists primarily (or even exclusively) of sports channel selectors. Continuing with this example, if it is noted that on weekday evenings news is typically presented on the display system when both indicate their presence by speaking their keywords, subsequently a second “child-father” personalization may be established using machine learning techniques in which the personalization consists primarily (or even exclusively) of news channel selectors, even though news may not be part of the child's individual personalization.

Keyword phrases may be configured to work on multiple devices using the same phrase with different types of content. For example, a keyword/phrase when uttered into a smart phone or Internet-connected vehicle while driving (as indicated by, e.g., positional information in a smart phone presenting content or the vehicle's GPS system) can result in presenting, on a display in the home, a personalized UI consisting of news and live sports selectable to tune to. In such an embodiment the moving device may communicate wirelessly with the in-hone device by means of, e.g., Wi-Fi (via a cloud server) or wireless telephony systems.

Yet again, portions of the display system capability may be restricted based on the presence of a particular person or type of person (using, e.g., speaker recognition) being present without an adult, whereas those portions of the system capability may not be restricted when the particular person or type of person is present but in the company of another individual or type of individual. As an example, when only a child is detected as being present based on the child speaking his keyword, without an adult, the capability of system settings adjustment may be restricted so that the child cannot change system settings. When an adult signifies her presence based on speaking her keyword, the settings feature is unlocked. Or, individual applications or all applications may be restricted when only a child is present and may be unlocked if an adult joins the child and speaks his or her keyword. Likewise, the ability to effect purchases using the display system may be restricted when only a child is present and no adult is present as indicated by not receiving any spoken keyword of an adult.

While the particular VOICE KEYWORD PERSONALIZATION is herein shown and described in detail, it is to be understood that the subject matter which is encompassed by the present invention is limited only by the claims.

1. A device comprising:
at least one computer memory that is not a transitory signal and that comprises instructions executable by at least one processor to:
receive digitized voice input;
execute speech recognition on the digitized voice input to render a speech result indicating at least one word;
execute speaker recognition on the digitized voice input to render a speaker result indicating at east one person;
responsive to the speech result satisfying a first criteria and the speaker result satisfying a second criteria, establish on a display device at least one setting associated with the at least one person;
responsive to the speech result satisfying the first criteria and the speaker result not satisfying the second criteria, change no setting on the display device;
responsive to the speech result not satisfying the first criteria and the speaker result satisfying the second criteria, change no setting on the display device; and
wherein the first criteria includes a match with a correct passcode, and the instructions are executable to, responsive to receiving a correct passcode from a correct associated speaker at least “N” times within a time period, stop changing settings on the display device for a timeout period regardless of whether a correct passcode is received from a correct associated speaker, N being an integer greater than one.

2. The device of claim 1, wherein the at least one setting includes an icon arrangement on a home page.

3. The device of claim 1, wherein the at least one setting includes a ratings limitation.

4. The device of claim 1, wherein the instructions are executable to:
responsive to the speech result satisfying a first criteria and the speaker result satisfying a second criteria, present on the display device a welcome message.

5. (canceled)

6. The device of claim 1, wherein the second criteria includes a match with a stored speaker template.

7, 8. (canceled)

9. A computer-implemented method, comprising:
executing speech recognition on digitized voice input to render a speech result indicating at least one word;
executing speaker recognition on the digitized voice input to render a speaker result indicating at least one person;
responsive to the speech result satisfying a first criteria and the speaker result satisfying a second criteria, establishing on the computing device at least one setting associated with the at least one person and otherwise not changing the at least one setting; and
responsive to receiving a correct passcode from a correct associated speaker at least “N” times within a time period, stop changing settings on the computing device for a timeout period.

10. The method of claim 9, comprising:
responsive to the speech result satisfying the first criteria and the speaker result not satisfying the second criteria, changing no setting on the computing device; and
responsive to the speech result not satisfying the first criteria and the speaker result satisfying the second criteria, changing no setting on the computing device.

11. The method of claim 9, comprising:
responsive to the speech result satisfying a first criteria and the speaker result satisfying a second criteria, presenting on the computing device a welcome message.

12. (canceled)

13. An apparatus, comprising:
at least one processor;
at least one display controllable by the at least one processor; and
at least one storage comprising instructions executable by the at least one processor for:
receiving first digitized voice input from first and second people at a first time of day;
executing speech recognition on the first digitized voice input to render a first multi-person speech result;
responsive to the first multi-person speech result satisfying a first criteria and responsive to the first time of day, establishing on the display a first multi-person personalization for the first and second people;
receiving second digitized voice input from the first and second people at a second time of day;
executing speech recognition on the second digitized voice input to render a second multi-person speech result;
responsive to the second multi-person speech result satisfying the first criteria and responsive to the second time of day, establishing on the display a second multi-person personalization for the first and second people, the second multi-person personalization being different from the first multi-person personalization, wherein at least one feature of at least the first multi-person personalization includes an icon arrangement on a home page.

14. (canceled)

15. The apparatus of claim 13, wherein at least one feature of at least the first multi-person personalization includes a ratings limitation.

16. The apparatus of claim 13, wherein the instructions are executable for:
responsive to the first speech result satisfying a first criteria and a speaker result satisfying a second criteria, presenting on the display a welcome message.

17. The apparatus of claim 13, wherein the first criteria includes a match with a correct passcode.

18. The apparatus of claim 16, wherein the second criteria includes a match with a stored speaker template.

19. The apparatus of claim 17, wherein the instructions are executable to:
responsive to receiving a correct passcode from a correct associated speaker at least “N” times within a time period, stop changing settings on the display for a timeout period.
